(19) United States
(12) Patent Application Publication
(10) Pub. No.: US 2010/0179921 A1
(43) Pub. Date: Jul. 15, 2010

(54) BEHAVIOR BASED PRICING FOR INVESTMENT GUARANTEE INSURANCE

(75) Inventor: Robert Scheinerman, Woodland Hills, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 12/636,308

(22) Filed: Dec. 11, 2009

Related U.S. Application Data
(60) Provisional application No. 61/143,725, filed on Jan. 9, 2009.

(51) Int. Cl. G06Q 40/00

(52) U.S. Cl. 705/36 R

(57) ABSTRACT

Aspects of the present disclosure allow an insurance company or other institution to manage its risk by establishing a charge consistent with hedging costs in offering a minimum guarantee on an underlying investment product to its customers. Such guarantees on underlying investment products may be included in, but are not limited to, variable annuities and contingent deferred annuities (CDA). Embodiments of a process are disclosed by which the charge for a guaranteed benefit in an investment product on underlying investments can vary by investor based on actual investment behavior. Advantageously, the insurance company or other institution can better manage its risk by reducing exposure from the actual experience compared to the investment behavior assumption and enable benefits to be charged more precisely for the actual risk taken (e.g., the insurance company can offer lower cost benefits for customers who are more risk averse).

### CROSS-REFERENCE TO RELATED APPLICATIONS

This patent application claims the benefit of priority to U.S. Provisional Patent Application No. 61/143,725, filed on Jan. 9, 2009, and entitled “Behavior Based Pricing For Investment Guarantee Insurance,” which is incorporated in its entirety herein by this reference.

### BACKGROUND OF THE INVENTION

Annuity products that include, but are not limited to, variable annuities and contingent deferred annuities (CDA) provide guaranteed benefits on underlying investment products for investors based on certain contingencies such as death, loss of investment, poor health or depletion of the account from withdrawals. Typically, the charge for these benefits is set at issue and is the same for all investors, sometimes varying for a broadly defined class (e.g., age group). The insurance company attempts to set a charge that will be adequate to cover the risks in aggregate without underwriting investors for investment behaviors. The actual cost of the benefits will vary based on actual investment decisions, such as the investments elected, degree of diversification and nature of trading.

At a given point in time, an investor will be allocated among various underlying investment choices with an option to change these investment choices at will within parameters established by the company. These decisions can have a considerable impact on the cost of the insurance guaranteed benefit and create unmanageable risks for the insurer. The company providing the guaranteed benefit takes on behavior risk because it charges the same charge regardless of the actual cost/risk associated with the customer's investment choices. This leads to a moral hazard problem in which a customer may take more risk in the presence of the guarantee. Moral hazard arises because the customer does not bear the full consequences of his actions. Therefore, the tendency or incentive for the customer to act carefully in his investment decisions can be reduced than would otherwise be the case, leaving the insurance company to bear the cost.

### BRIEF SUMMARY OF THE INVENTION

Aspects of the present disclosure allow an insurance company or other institution (collectively, the “provider”) to reduce its risk in offering a guaranteed benefit on an underlying investment product to its customers. The guaranteed benefit may be included in, but is not limited to, variable annuities and contingent deferred annuities (CDA) that are issued as individual and group, immediate and deferred annuities. Embodiments of a process are disclosed by which the charge for the guaranteed benefit based on an investment product (collectively called the “guarantee”) can vary by investor based on actual investment behavior. Advantageously, the provider of the guarantee can better manage its risk by using the actual experience compared to the investment behavior assumption and enable the cost of the benefits to be priced more precisely for the actual risk taken (e.g., the provider can offer lower cost benefits for customers who are more risk averse).

In one embodiment, a charge for the guarantee can be based on the rules and constraints of the guarantee. A charge for the guarantee can be based on the investment choices of its customer, i.e., the customer's investment allocation. High risk investment choices made by a customer can result in a change to a higher charge for the guarantee to allow the provider to reduce its risk.

In yet other embodiments, a benefit of the guarantee, such as a minimum guaranteed rate of return, can be calculated based on the customer investment allocation. The provider of the guarantee can offer a lower benefit based upon a customer's investment allocation including a predetermined level of high risk investment choices.

The customer can be notified of the change in the charge or the amount of the benefit based upon the customer's investment allocation. The customer can choose either to accept the charge or benefit change or to change his/her investment allocation for the guarantee to avoid the charge or benefit change.

### BRIEF DESCRIPTION OF THE SEVERAL VIEWS OF THE DRAWING(S)

FIG. 1 is a schematic view of system architecture in keeping with the disclosed principles.

FIG. 2 is a flow diagram that illustrates an exemplary embodiment of a method of administering a guarantee according to an aspect of the invention.

FIG. 3 is a flow diagram that illustrates an exemplary embodiment of a method of administering a guarantee according to an aspect of the invention.

FIG. 4 is a series of charts that illustrate the charge calculation for a first customer investment allocation model and a second customer investment allocation model.

FIG. 5 is a flow diagram that illustrates an exemplary embodiment of a method of administering a guarantee according to an aspect of the invention.

FIG. 6 is a continuation of the flow diagram of FIG. 5.

FIG. 7 is a continuation of the flow diagram of FIGS. 5 and 6.

FIG. 8 is a flow diagram that illustrates an exemplary embodiment of a method of administering a guarantee according to an aspect of the invention.

FIG. 9 is a flow diagram that illustrates an exemplary embodiment of a method of administering a guarantee according to an aspect of the invention.

### DETAILED DESCRIPTION OF THE INVENTION

Aspects of the present invention allow the provider of the guarantee to charge more consistently with its risk in providing a minimum guarantee on an underlying investment product. The invention is applicable to numerous embodiments of an investment product and is not limited in its application to annuity products with minimum guarantees.

Aspects of the invention allow a provider of the guarantee to protect itself from loss by changing at least one of the charges and the benefit associated with a guarantee based on the underlying investment choices made by the customer and the rules and constraints of the guarantee. One example of an annuity product is a variable annuity that is a single product containing underlying investment options and a guarantee. Charges for the guarantee are associated with investment choices so that the guarantee charge is based on investor behavior. Another example is a contingent deferred annuity (CDA) that provides a guaranteed annuitization stream upon depletion of an underlying investment, subject to certain investment and withdrawal rules. The charge for the CDA is based on investor behavior (i.e. depending on which of the available investments are selected and in what proportion).

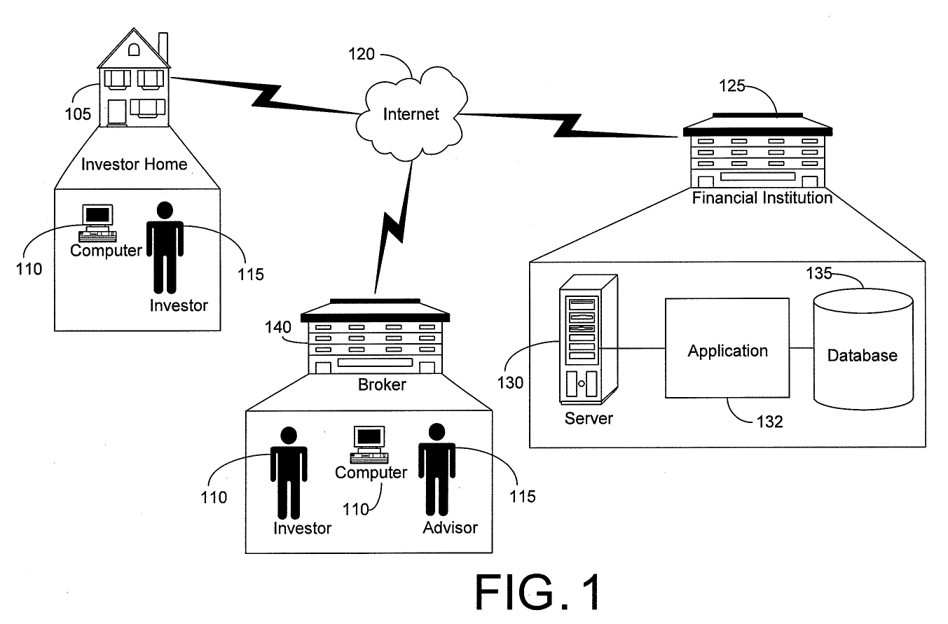

FIG. 1 is a general overview of system architecture in keeping with the disclosed principles. In the illustrated embodiment of the invention, an investor/customer 114 has purchased a product with a minimum guarantee from a provider 125 through a broker 140. When purchasing the investment product with the guarantee, a customer establishes an account with the broker 140 and purchases a guarantee from a guarantee provider 125, for which the provider charges an initial fee for the guarantee. The account associated with the guarantee has a certain amount of funds to be invested by the investor 115. Parameters and constraints associated with the guarantee may allow the investor 115 the flexibility to invest the funds in a risk diverse array of underlying investments. If the investor 115 makes high risk investment choices, then the guarantee provider may implement a software application 132 on a computer server 135 to examine a database 135 of information to calculate a higher fee for the guarantee given the investor's high risk choices. The illustrated embodiment further shows that the investor 115 may make investment choices at his home 105 across the Internet 120, or with an advisor 115 employed by a broker 140. Other aspects of the invention include an insurance company representative receiving investment instructions from a customer or broker. The representative then enters the customer investment information (per the instructions) into the institution database using the appropriate software applications. Note that embodiments of the invention may include one or more servers, software applications, and databases.

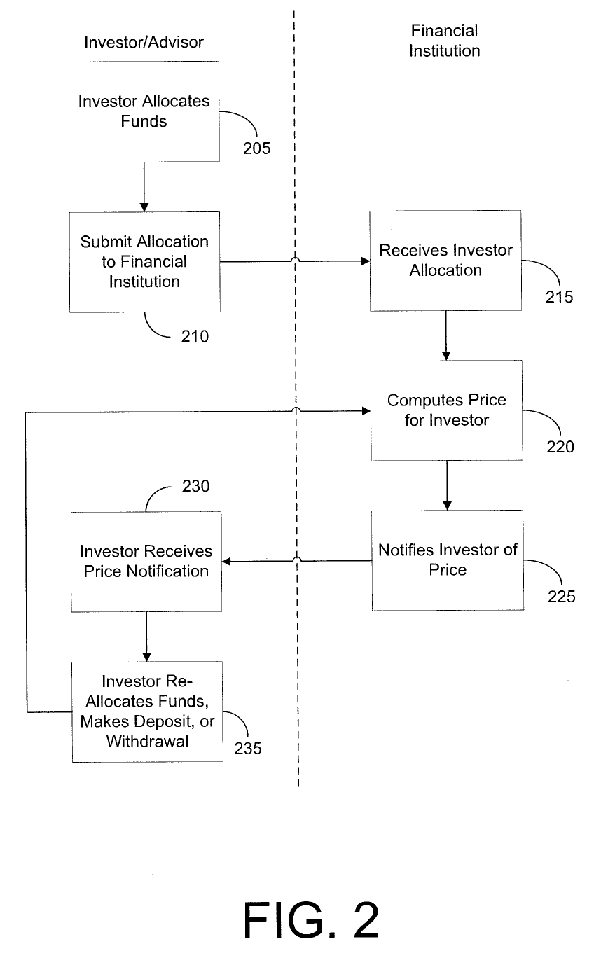

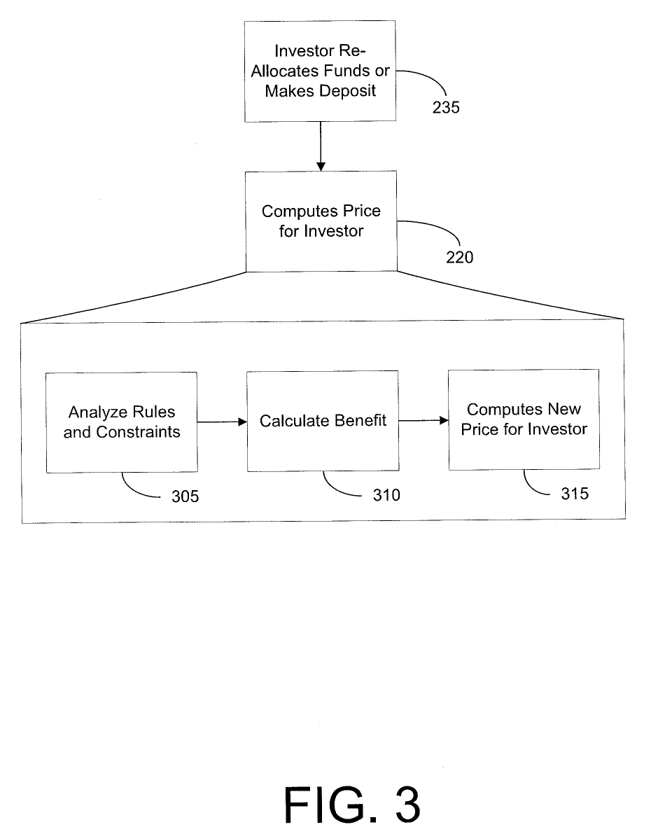

FIG. 2 is a flow diagram that illustrates an exemplary method of an aspect of the invention. At a step 205, an investor makes an investment choice and allocates funds accordingly. This investment choice may be done through an electronic user interface across a computer networked system. At a step 210, a software application submits the investor fund allocation to the provider of the guarantee. At a step 215, the provider receives the investor allocation. At a step 220, the provider's software application computes a new fee for the guarantee given the customer's fund allocation. At a step 225, the provider notifies the investor of the new fee for the guarantee. At a step 230, the investor receives the fee notification from the provider's server and software application across a network to an electronic user interface. At a step 235, the investor re-allocates funds, makes a deposit or withdrawal from his account. The provider software application then re-computes the charge of the guarantee for the customer at a step 220. FIG. 3 is another flow diagram that illustrates some of the sub-steps in computing a new charge of the guarantee for the customer. At a step 305, a system analyzes the business rules and constraints applicable to the guarantee, and customer investment choices. At a step 310, the software application calculates the benefit, or minimum guarantee, that the provider furnishes to the customer. At a step 315, the software application computes the new fee for the customer.

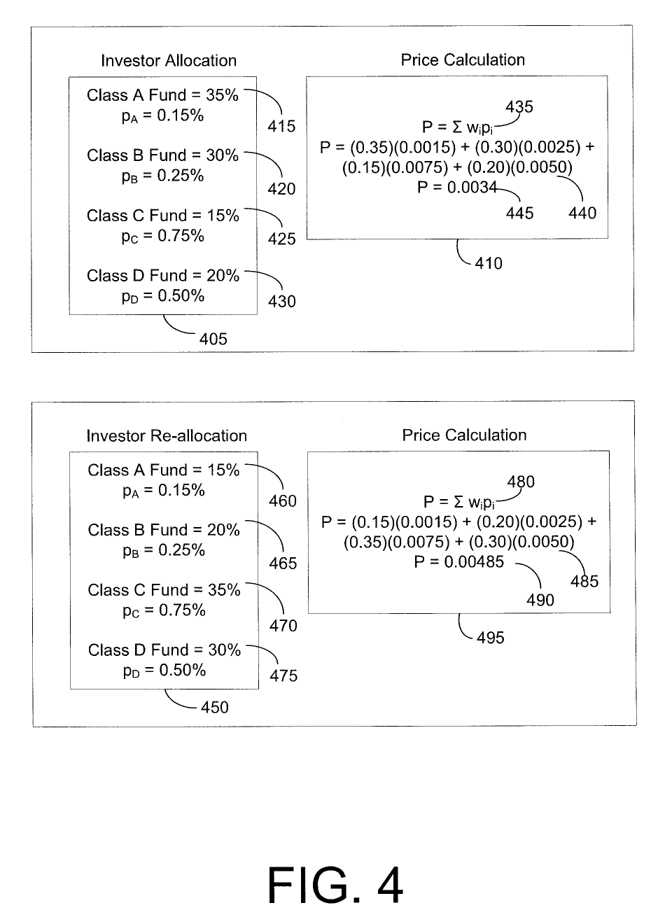

FIG. 4 is a series of charts that illustrates an aspect of the invention. Initially, when an investor purchases a guarantee with a minimum guarantee, the provider offering the guarantee calculates an initial charge. After a period of time (e.g. monthly, quarterly, annually, etc.) an investor may be assessed a new charge for the guarantee based on his investment decision during the previous time period.

The charge for the guarantee can differ by each underlying investment choice based on the expected risk characteristics of the fund. A base charge for a benefit can be based on the charge (p) associated with each fund and its weighting (w) in each of the n funds as follows to determine the overall charge, P:

$$P = {\sum }_{i = 1}^{n} {w}_{i} {p}_{i}$$

The investment allocation of the investor can be defined by the weighting allocation array [wᵢ]. The charge, P, can remain fixed so long as the weights remain unchanged and no payment is paid. If the investor changes the allocation or makes an additional payment, then a new charge can be established. The actual charge to the investor can be pro-rated based on the period of time that the given allocation was in effect. In other embodiments, the charge for a predetermined period can be based on the highest charge determined by the pricing formula above for a given allocation selected by the investor for that period and never decreases due to a reallocation to a less expensive allocation. In yet another embodiment, the charge for the guarantee associated with each fund (pᵢ) may change under certain market conditions. The charge per fund is based on historical results (represents the risk of the fund) and current market conditions (represent the current cost of hedging).

In other embodiments, other pricing approaches can be implemented. For example, in some embodiments, the charge can be limited to a predetermined range having a minimum (such as zero, for example) and a maximum established by the insurer. In other embodiments, a charge for a predetermined period of time (quarter, year, etc.) can be based on the highest charge for the guarantee associated the funds selected and re-calculated at the end of the period irrespective of any allocations to a less risky fund made during the period. In yet other embodiments, the algorithm to calculate the charge for the annuity insurance product is based upon the amount of the customer investment allocation that is allocated to at least one of a certain fund, a selected risk factor, and a selected economic factor.

A chart 405 displays an exemplary allocation of account funds by an investor into four different funds. The investor initially allocates account funds in the following manner: 1) 35% of account funds are allocated to a class A fund with an associated charge for the guarantee of p_{A}=0.15% (415); 2) 30% of account funds are allocated to a class B fund with an associated charge of p_{B}=0.25% (420); 3) 15% of account funds are allocated to a class C fund with an associated charge of p_{C}=0.75% (425); and 4) 20% of account funds are allocated to a class D fund with an associated charge of p_{D}=0.50% (430). The provider of the guarantee can assess a higher charge, pᵢ, where i=A, B, C, or D in the example shown in FIG. 4, for underlying funds that are a higher risk. For example, a risky small capital equity fund may have a higher charge for the guarantee than a conservative domestic bond fund. Each fund charge, pᵢ, is determined using mathematical modeling techniques known to those skilled in the art that may include analyzing historical results of a fund, then determining the risk posed to the guarantee provider by an investor allocating a portion of his/her account into that fund. A chart 410 illustrates an initial charge calculation performed by a software application based on an investor's initial allocation of funds 410. The charge is computed by summing the percent amount of assets in a certain fund, multiplied by the charge of that fund (435, 440). The initial charge for the exemplary investor allocation is computed as 0.34% of the total assets in the investor account 445.

FIG. 4 shows another chart 450 where the investor reallocates the account funds among the four class funds. Suppose the investor re-allocates the account funds on the first day of a time period. Further, the investor re-allocates account funds during the entire time period in the following manner: 1) 15% of account funds are allocated to a class A fund with an associated charge of p_{A}=0.15% (460); 2) 20% of account funds are allocated to a class B fund with an associated charge of p_{B}=0.25% (465); 3) 35% of account funds are allocated to a class C fund with an associated charge of p_{C}=0.75% (470); and 4) 30% of account funds are allocated to a class D fund with an associated charge of p_{D}=0.50% (475). A chart 495 illustrates a charge calculation for the guarantee performed by a software application based on the investor's re-allocation of funds. The charge for this re-allocation is computed by summing the percent amount of funds in a certain fund, multiplied by the charge of that fund 485. The charge for the guarantee of the exemplary investor's re-allocation is computed as 0.485% of the total funds in the investor account 490. Thus, when the current time period ends, the provider charges a higher charge (0.485%) than the initial charge (0.34%) to the investor for the next time period because the investor has made riskier investment choice than his initial allocation.

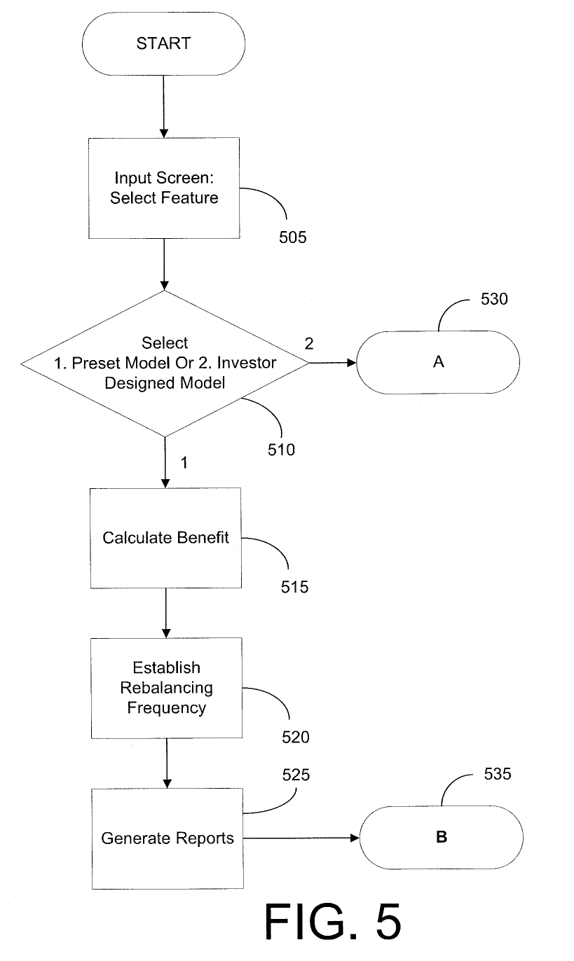

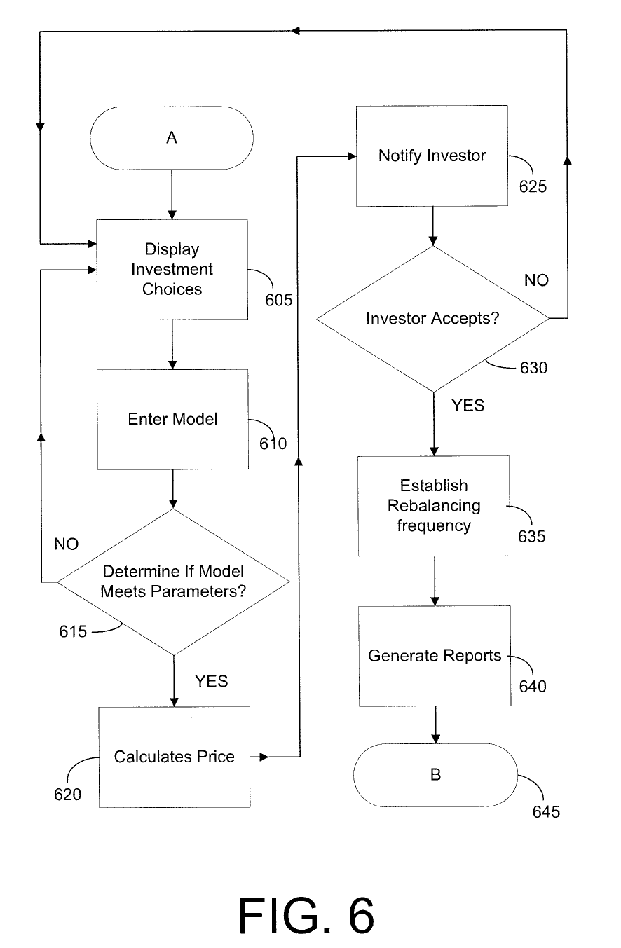

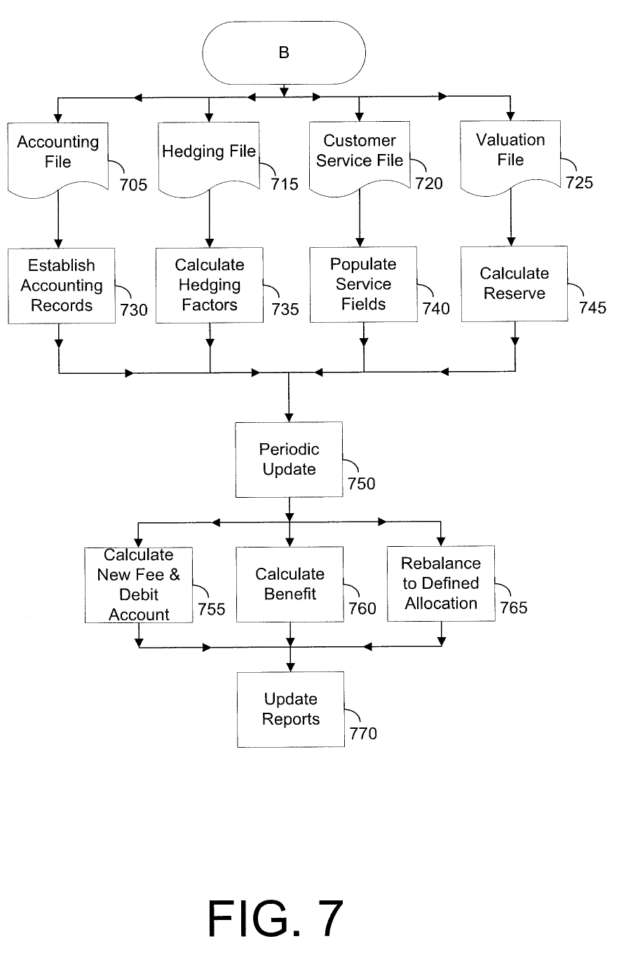

FIG. 5 is another flow diagram that that illustrates an exemplary method of an aspect of the invention. At a step 505, an investor or advisor interacts with an electronic user interface in a computer networked system that allows the investor or advisor to select a feature of a purchased guarantee. At decisional 510, the investor either chooses a preset investment model provided by the provider or designs his own investment model. If the investor chooses a preset investment model, then the exemplary method proceeds to step 515. However, if the investor designs his own investment model, then the exemplary method proceeds to another exemplary method A at a step 530. Exemplary method A will be discussed when describing FIG. 6. At a step 515, the guarantee provider's software application calculates the benefit for the guarantee based on the investment model submitted for the investor. For example, the benefit may be a minimum guarantee on an underlying investment model. At a step 520, the provider's software application establishes a rebalancing frequency where the investor funds are re-allocated to balance risk. At a step 525, the provider's computer system generates reports to be submitted to various departments within the provider. At a step 535, the exemplary method proceeds to another exemplary method B that will be discussed when describing FIG. 7.

FIG. 6 is another flow diagram that illustrates an exemplary method of an aspect of the invention. At a step 605, the provider displays the available investment choices to the investor. The investment choices may be presented by a software application through an electronic user interface across a computer network system. At a step 610, the investor chooses an investment model and it is entered into the provider's computer system. At decisional 615, a provider's software application determines whether the newly entered model complies with parameters and constraints established for the customer's investment choices and the guarantee. If the software application determines that the entered model does not meet the guarantee's parameters and constraints, then the exemplary method proceeds to a step 605 and re-displays the available investment choices to the investor. However, if the newly entered model does meet the parameters and constraint of the guarantee and customer's investment choices, then the software application calculates a new charge for the newly entered model at a step 620. At a step 625, the provider's software application notifies the investor of the charge of the guarantee. This notification may include but is not limited to, an e-mail, voicemail, instant message, text message, letter, or any other appropriate means. At decisional 630, the investor decides whether to accept the charge of the guarantee calculated by the guarantee provider. If the investor does not accept the charge, then the provider re-displays the available investor choices to the investor for him to select a different investment model at a step 605. However, if the investor does accept the charge, then the exemplary method proceeds to a step 635 where the provider establishes a rebalancing frequency. At a step 640, the provider generates reports to be distributed to different departments within the provider. At a step 645, the exemplary method proceeds to exemplary method B that will be discussed when describing FIG. 7.

FIG. 7 is another flow diagram that that illustrates an exemplary method of an aspect of the invention. At a step 705, data from generated reports (for example the generated reports that are produced at a step 525), are placed in an accounting file. At a step 730, the data from the accounting file is used to establish accounting records for the investor and the guarantee. At a step 715, data from the generated reports are placed in a hedging file. At a step 735, a provider's software application calculates hedging factors. At a step 720, data from the generated reports are placed in a customer service file. At a step 740, a software application populates service fields from the data within the customer service file. At a step 725, data from the generated reports are placed in a valuation file. At a step 745, the software application calculates the reserve. At a step 750, the data within a set of files is periodically updated. At a step 755, a software application calculates a new fee for the customer's guarantee and debits the investor account. At step 760, the software application calculates the benefit for the guarantee. For example, a minimum guarantee for the guarantee may be reduced in light of risky investment choices made by the investor. At a step 765, a software application may rebalance an investor account to a defined allocation. At a step 770, the software application updates reports to the various departments of the provider.

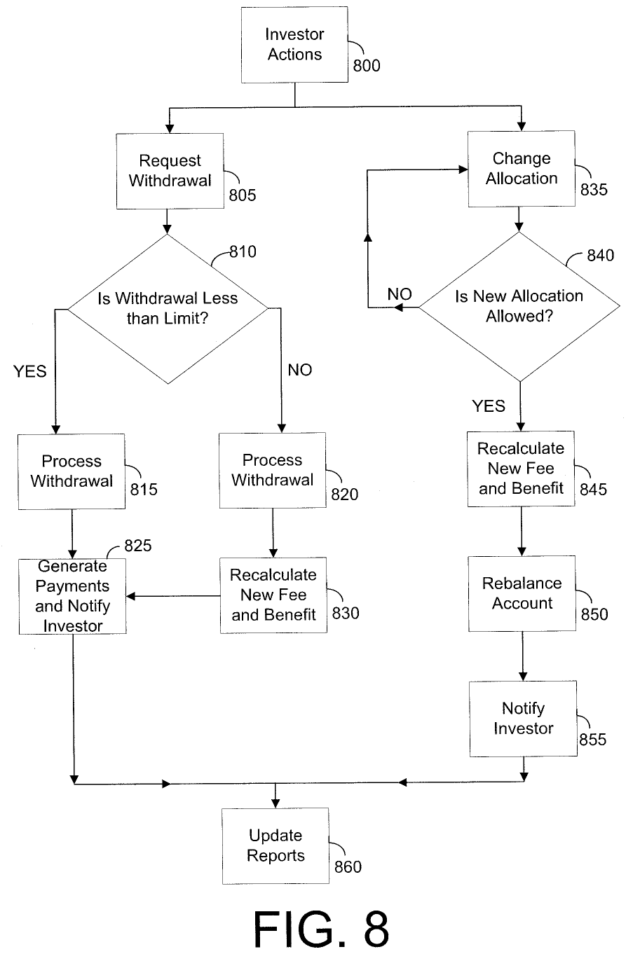

FIG. 8 is another flow diagram that illustrates an exemplary method of an aspect of the invention. At a step 800, an investor may perform an action such as a withdrawal of funds or a change in fund allocation. At a step 805, the investor may request a withdrawal from his account associated with the guarantee. At decisional 810, the software application determines whether the withdrawal is less than limit. If the withdrawal is less than the limit, then the software application processes the withdrawal at a step 815. At a step 825, the underlying fund generates payment to the investor based on the withdrawal request, and then notifies the investor. This notification may include but is not limited to, an e-mail, voicemail, instant message, text message, letter, or any other appropriate means. If the withdrawal is not less than the limit, then at a step 820, the software application processes the withdrawal. At a step 830, a software application recalculates a new fee and benefit for the guarantee based on the withdrawal, after which the exemplary method may proceed to a step 825. At a step 860, the software application updates reports to the various departments of the guarantee provider.

At a step 835, the investor acts by changing the allocation of funds between different investment choices. At decisional 840, a software application determines whether the new allocation is allowed based on parameters and constraints imposed on the customer investment choices and the guarantee. If the new allocation is not allowed, then the investor may re-allocate account funds in a step 835. If the new allocation is allowed, then at a step 845, the software application recalculates a new fee and benefit for the guarantee. At a step 850, the provider's software application rebalances investor account to reduce risk on the investment. At a step 855, the provider notifies the investor of the new fee and benefit. This notification may include but is not limited to, an e-mail, voicemail, instant message, text message, letter, or any other appropriate means. At a step 860, the software application updates reports to the various departments of the provider.

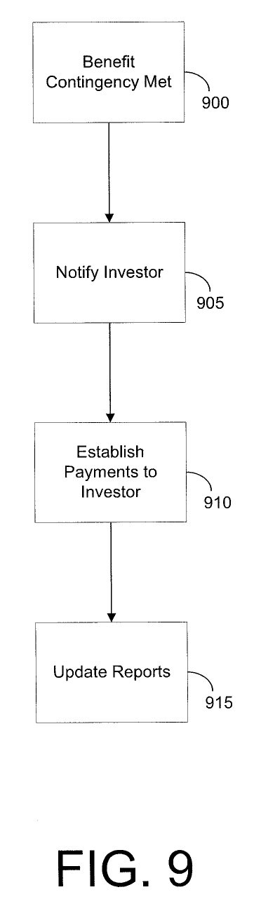

FIG. 9 is another flow diagram that illustrates an exemplary method of an aspect of the invention. At a step 900, a benefit contingency threshold is met. For example, the investor has made low risk investment choices for twelve months such that the guarantee has met the contingency benefit of a minimum bonus of 6% of account funds. At a step 905, the provider notifies the investor that the benefit contingency threshold is met. This notification may include but is not limited to, an e-mail, voicemail, instant message, text message, letter, or any other appropriate means. At a step 910, the provider distributes payments to the investor according to the benefit. At a step 915, the software application updates reports to the various departments of the provider.

In other embodiments, the charge can be adjusted downward if the investor selects to automatically rebalance his asset allocation on a periodic basis. Such re-balancing can reduce the drift away from a given predicted performance, providing stability in the investment characteristics. In some embodiments, the selection of automatic asset allocation rebalancing can reduce the charge for the benefit by a predetermined percentage.

In yet other embodiments, the charge can be adjusted upward if the investor changes allocations frequently. Such frequent allocation changes affect the character of the investments in a way that makes it more difficult to hedge. In some embodiments, if the investor changes the allocation within a predetermined period of time from his last allocation change, the charge for the benefit can be increased by a predetermined percentage for a set period of time. In other embodiments, whether the change in investment allocation is allowed can be based upon at least one of the following criteria: determining whether a set period of time has elapsed since the current investment allocation was selected and determining whether the change in the investment allocation was received prior to a certain duration of time.

In still other embodiments, the charge can be adjusted downward if the investor diversifies his allocation. In comparing two investment choices which would generate the same charge in the formula above, the one with more funds would be more likely to have correlation offsets. In some embodiments, if the investor selects a number of funds above a predetermined number for his investment allocation, the charge for the benefit can be reduced by the number of funds included in the allocation multiplied by a predetermined percentage.

It would be apparent to a person of ordinary skill in the art that embodiments of the invention include changing charges and benefits for the investment products described herein for one or more customers. Consequently, aspects of the exemplary computer system and computer implemented method described in the disclosure allow a provider to calculate the charges and benefits for the investment products described herein for its many customers and for the many investment choices made by each customer. In addition, embodiments of the invention physically transform (by either increasing or decreasing) the charges, hence the money received by the provider, for the investment products described herein based on customers' investment choices. The provider may notify a change in charge to each customer through means described in the disclosure as well as by a physical invoice.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. For example, embodiments of the invention can be applied to any form of investment insurance that allows for investments in a finite set of alternatives. Other embodiments of the invention can be applied to 403(b) accounts, 401(k) accounts, and non-VA guarantees on mutual funds or other investments.

The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of administering an investment product account of a customer, the investment product account having a value, the investment product being valued based on a plurality of investment choices into which the value can be distributed, the method comprising:
receiving an application for the investment product providing a guaranteed benefit to be administered on the computer system; and
receiving an investment allocation from the customer through an electronic user interface across a communication network using a software application as part of a computer system.

2. A method for behavior based pricing for an investment guarantee benefit of an investment product, the method comprising:
receiving an investment allocation from one or more customers for the investment product through an electronic user interface across a communication network using a software application as part of a computer system;
calculating a charge for the investment product for each customer using an algorithm based on the rules and constraints of the investment product and a customer investment allocation model using a software application as part of a computer system within a guarantee provider; and
notifying a customer of the charge for the investment product based on the customer investment allocation by a provider.

3. The method according to claim 2, further comprising:
analyzing the rules and constraints associated with the customer allocation model and the investment product by a provider; and
calculating the benefit for the investment product based on the rules and constraints of the investment product and the customer investment allocation using a software application as part of the computer system within the guarantee provider.

4. The method according to claim 2, wherein the algorithm to calculate the charge for the investment product is Σwᵢpᵢ wherein:
i is one of a plurality of investment funds within the customer investment allocation model;
wᵢ is the weight associated for investment fund i based on the percentage investment fund i is of the total customer investment allocation model; and
pᵢ is the charge for investment fund i that is a based on the percent of funds in investment fund i of the customer investment allocation model.

5. The method according to claim 2, further comprising:
displaying available investment choices to one or more customers through an electronic user interface across a communication network using a software application as part of the computer system within the guarantee provider;
establishing a rebalancing frequency to balance risk in one or more customer investment choices using a software application as part of the computer system within the guarantee provider;
generating reports for one or more customers of each customer investment model for an investment product using a software application as part of the computer system within the guarantee provider;
updating reports for one or more customers of each customer investment model for an investment product using a software application as part of the computer system within the guarantee provider; and
transmitting reports to a plurality of functional departments of the guarantee provider using a software application as part of the computer system within the guarantee provider.

6. The method according to claim 5, wherein the data in the reports are used to create files using a software application as part of the computer system within the guarantee provider, wherein the files are:
an accounting file for each customer to establish accounting records;
a hedging file to calculate hedging factors;
a customer service file to populate service fields; and
a valuation file to calculate reserve.

7. The method according to claim 2, further comprising:
receiving a change in an investment allocation from one or more customers through an electronic user interface across a communication network using a software application as part of the computer system within the guarantee provider; and
determining whether the change in the investment allocation is allowed based on the rules and constraints of the investment product using a software application as part of the computer system within the guarantee provider.

8. The method according to claim 2, wherein determining whether the change in investment allocation is allowed is based upon at least one of the following criteria: determining whether a set period of time has elapsed since the current investment allocation was selected and determining whether the change in the investment allocation was received prior to a certain duration of time.

9. The method according to claim 2, wherein determining whether the change in investment allocation is allowed is based upon at least one of the following criteria: determining whether the allocation to an investment meets the minimum or maximum requirements established by the company.

10. The method according to claim 2, wherein notifying a customer of a charge includes a notification message, and wherein the notification message is selected from a group consisting of an e-mail, a voicemail, an instant message, a text message, a letter, or a web page.

11. The method according to claim 2, wherein the charge for the investment product is based upon the amount of the customer investment allocation that is allocated to at least one of a certain fund, a selected risk factor, and a selected economic factor.

12. A system for behavior based pricing for an investment guarantee benefit of an investment product, comprising:
at least one server that implements a software application adapted to calculate a charge for the investment product for each customer using an algorithm based on rules and constraints of the investment product and a customer investment allocation model;
at least one database operably arranged with the at least one server to store customer investment product information therein;
a communication network operably arranged with the at least one server, the communication network providing electronic user interfaces to one or more customers and being adapted to receive an investment allocation from one or more customers for the investment product and to transmit the investment allocation to the at least one server to calculate the charge for the investment guarantee of the investment product.

13. The system according to claim 12, wherein the electronic user interface is selected from the group consisting of a web graphical user interface, Internet user interface, mobile phone user interface, and an instant message user interface.

14. The system according to claim 12, wherein the communication network is selected from the group consisting of, including but not limited to, a voice communication network, a computer data network, a wireless network, a WiFi network, a WiMAX network, a local area network, a wide area network, a metropolitan area network, a cellular network, and the Internet.
